(19) United States
(12) Patent Application Publication
(10) Pub. No.: US 2017/0016669 A1
(43) Pub. Date: Jan. 19, 2017

(54) Device for Pre-Heating Cement Raw Meal for Cement Clinker Production

(71) Applicant: HOLCIM TECHNOLOGY LTD, Rapperswil-Jona (CH)

(72) Inventor: Urs GASSER, Rüfenach (CH)

(21) Appl. No.: 15/121,313

(22) PCT Filed: Feb. 17, 2015
(86) PCT No.: PCT/IB2015/000174

§ 371 Date: Aug. 24, 2016

(30) Foreign Application Priority Data
Feb. 25, 2014 (AT) A 129/2014

(51) Int. Cl. F27B 7/20; F27B 15/00; F27D 13/00; C04B 7/43

(52) U.S. Cl. CPC F27B 7/2033; C04B 7/432; F27B 15/003; F27D 13/00

(57) ABSTRACT

The device for pre-heating cement raw meal for the cement clinker production comprises at least one heat exchanger line for charging cement raw meal in countercurrent flow to the hot gases drawn through the heat exchanger line and a supporting structure (19) for the at least one heat exchanger line, wherein the heat exchanger line comprises a plurality of heat exchangers (8, 9, 10) which are interconnected and through which flow can pass consecutively. The supporting structure (19) comprises stands (20) which jointly form a triangular outline (21) and serve to transfer load into at least one foundation.

The invention relates to a device for pre-heating cement raw meal for the cement clinker production comprising at least one heat exchanger line for charging cement raw meal in countercurrent flow to hot gases drawn through the heat exchanger line and a supporting structure for the at least one heat exchanger line, wherein the heat exchanger line comprises a plurality of heat exchangers which are interconnected and through which flow can pass consecutively.

In the production of cement clinker from cement raw meal the raw meal is usually preheated in at least one heat exchanger line, which is flowen through by exhaust gas of a rotary kiln. The heat exchanger line usually consists of gas-suspension preheaters, more particularly cyclone separators. The raw meal is heated in countercurrent flow to the combustion gases drawn off from the rotary kiln, wherein at an appropriate temperature pre-calcination can also occur. The hot process gas from the rotary kiln can thus be thermally utilised. It is known to connected a plurality of such gas-suspension heat exchangers in series so that the hot process gas, which leaves the rotary kiln at temperatures of around 1100° C., is cooled in several steps to temperatures of 350° C. or even 290° C. depending on the number of steps. The number of steps in turn essentially depends on the drying requirements of the material being used respectively, wherein the efficiency of the heat transfer is essentially determined by the raw meal dispersion in the gas flow and a corresponding high degree of separation in the cyclone.

In installations with a high material throughput it is necessary to arrange at least two heat exchanger lines in parallel.

Due to their relatively large volume, the heat exchangers are generally built into a so-called heat exchanger tower. The heat exchanger tower comprises a tower-like supporting structure on which the heat exchangers are supported. When constructing a cement production plant the heat exchanger tower is the most expensive component, because the construction costs are generally mainly dependent on the construction volume, irrespective of whether a plant component is made of steel, concrete or a combined steel/concrete structure. The heat exchanger tower can be up to 120 m in height and in the case of a one-line installation a ground area up to 200 m² can be covered so that the construction costs are correspondingly high. In addition the construction has to be specially adapted to the local environmental influences, such as earthquakes and the wind situation.

As a rule the supporting structure of the heat exchanger tower has a rectangular outline, wherein the heat exchangers as well as all the connecting pipes linking them, the platforms, struts and similar elements are arranged within the rectangular outline. The supporting structure consists of stands which serve to transfer loads into a foundation, wherein mostly at least four stands are provided, which form the corners of the rectangular outline. The drawback of such a supporting structure is that the construction volume and thus the building costs are high. Furthermore, the volume is not optimally utilised, because the heat exchangers of a heat exchanger line are often arranged within a certain radius about a central vertical axis, meaning that the corner areas of the rectangular supporting structure are not utilized.

The invention therefore aims to significantly reduce the construction costs of a heat exchanger tower and, possibly, to achieve a better use of space.

To solve this task, in accordance with the invention the device of the type set out in the introduction is essentially further developed in such a way that the supporting structure comprises stands which jointly form a triangular outline and serve to transfer loads into at least one foundation. The invention therefore departs from the conventional notion that the supporting structure of a heat exchanger tower has to be quadratic or rectangular. In accordance with the invention the supporting structure has a triangular instead of a rectangular outline. This leads to a significant reduction in construction volume as with the same configuration and arrangement of the heat exchangers the outline of the heat exchanger tower can be reduced. The triangular outline can be utilised by the heat exchangers more efficiently than a rectangular outline, whereby less room remains unutilised.

If, as it is the case in a preferred embodiment, each stand has its own foundation the structural volume and thus the construction costs for the foundations can be reduced via the triangular structure.

Compared with conventional supporting structures the embodiment according to the invention also has static advantages. Thus, a supporting structure with only three stands, if compared to one that has more than three stands, does not exhibit tension states if the foundation of a stand subsides.

If in connection with the invention it is stated that the stands, which transfer load into a foundation, jointly form a triangular outline, it is meant that none of the stands of the respective supporting structure, which transfer load into a foundation, is arranged outside of the triangular outline. The definition of the triangular outline therefore includes all the stands of the supporting structure serving to transfer load into a foundation.

The triangular outline of the supporting structure is preferably achieved in that three stands arranged in a triangle are provided. An arrangement of three stands in a triangle guarantees the same stability as conventional constructions with a rectangular outline consisting of four stands.

The stands preferably essentially extend over the entire height of the heat exchanger line.

The stands are, as known, anchored in a foundation or fastened to another ground structure or structure close to the ground so that the vertical supporting load of the stands produced by the heat exchangers can be transferred into the foundation and/or the ground. To be considered as stands in the meaning of the invention, which form the triangular outline, are such stands that transfer the main load of the heat exchangers line into a foundation. These are thus main stands, wherein secondary stands can also be provided.

The stands can be formed of reinforced concrete columns or the like.

In principle the individual stands can be designed in any way. For example the stands can have a quadratic, rectangular or round cross-section. The stands can be solid or hollow, wherein in the case of a hollow design the stands can be used for the passage of all kinds of lines, such as water pipes, air pipes or power lines. The hollow space of a stand can also accommodate a personnel elevator.

Particularly good stability can be achieved in accordance with a preferred embodiment in that the stands are arranged inclined towards each other. The three stands arranged in a triangle then form the side edges or a three-sided pyramid stump. In particular, the stands can each be at an angle of 1-10° to the vertical.

A particularly rigid structure is preferably achieved via connecting the stands to each other by means of struts or platforms, which are preferably arranged within the triangular outline. The platforms can be provided in several storeys, which are allocated to the individual heat exchanger levels, so that simple access to the heat exchangers is guaranteed.

According to a preferred embodiment the heat exchangers are built as suspension heat exchangers, more particularly as cyclone separators, which is known per se.

The heat exchangers can essentially be arranged within the triangular outline generated by the stands. However, the structural volume of the supporting structure of the heat exchanger tower can be further reduced in that the heat exchangers project beyond the triangular outline with part of their volume, particularly beyond the side edges of the triangular outline.

According to the invention the embodiment of the supporting structure of the heat exchanger tower is particularly suitable for accommodating a single heat exchanger line. For this purpose the invention is preferably further developed such that only one heat exchanger line is supported by the supporting structure with its stands forming the triangular outline. The structural space of the supporting structure can be particularly efficiently utilised if, as it is the case with a preferred embodiment, the heat exchangers of the one heat exchanger line are arranged in a central symmetrical manner about a central axis. Particularly preferably the central axis runs essentially through the intercentre of the triangular outline.

If the installation requires several parallel heat exchanger lines, this can be realised in accordance with the invention in that several, more particularly at least two, of the supporting structures according to the invention are combined with each other. According to a further aspect the invention therefore relates to a combination of a first heat exchanger tower with at least one further directly adjoining heat exchanger tower, wherein two stands of the supporting structure of the first heat exchanger tower are at the same time stands of the second heat exchanger tower, wherein the first heat exchanger tower and the at least one further heat exchanger tower only has one heat exchanger line respectively. In case of two heat exchanger towers the two triangular outlines of the two heat exchanger towers jointly form a rhombic outline. In doing so the rhombic shape does not include the special case of a square.

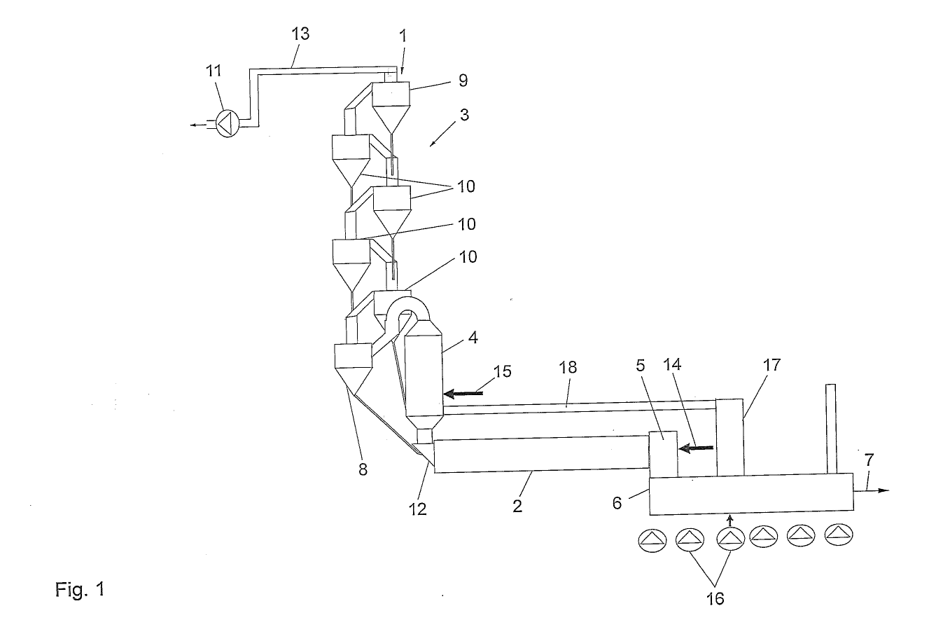

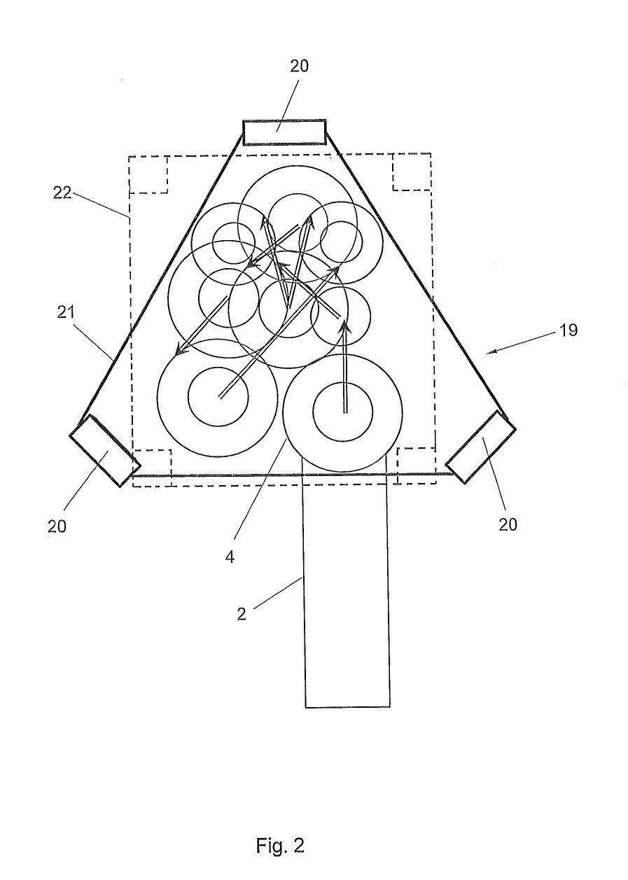

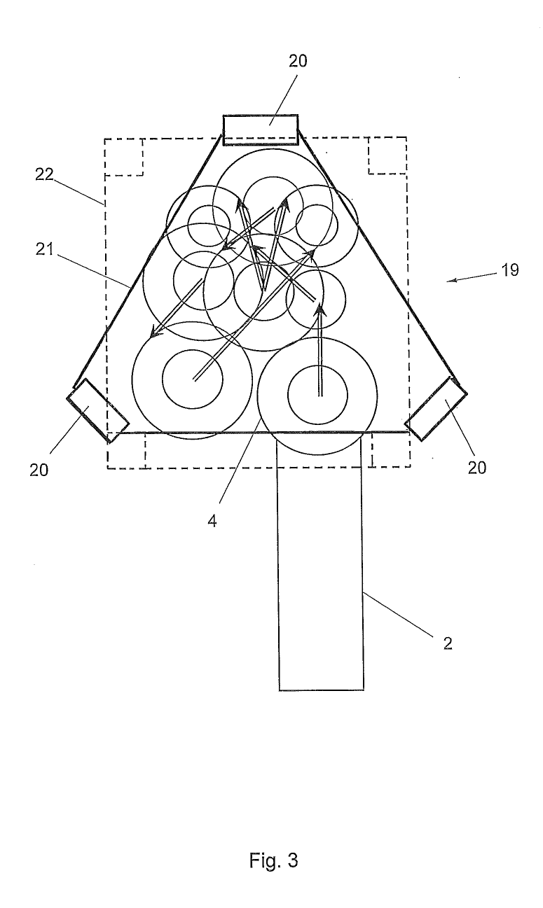

The invention will be explained below in more detail with the aid of the figures shown schematically in the drawing. FIG. 1 shows a cement clinker production plant according to the prior art, FIG. 2 a first embodiment of a heat exchanger tower according to the invention and FIG. 3 a second embodiment of a heat exchanger tower according to the invention.

A cement clinker production plant is schematically shown in FIG. 1, in which at point 1 charged raw meal is preheated in a preheater 3 in countercurrent flow to the hot exhaust gases of a clinker kiln 2 and calcinated in a calcinator 4. The clinker leaves the clinker kiln 2 at point 5 and is cooled in a clinker cooler 6. The cooled clinker leaves the clinker cooler 6 at point 7.

The preheater 3 can comprise one or more heat exchanger lines. In the drawing one line is shown. The line has a plurality of cyclone gas suspension heat exchangers connected one after the other, wherein the first gas suspension heat exchanger is designated with 8, the last gas suspension heat exchanger with and the gas suspension heat exchanger arranged in between with 10. The kiln fan 11 produces the required negative pressure so that the kiln exhaust gas emerging on the hot meal output side 12 of the clinker kiln 2 is drawn through the calcinator 4 and the consecutively connected gas suspension heat exchangers 8, 10, and 9 and the hot gas extractor 13.

Fuel is supplied to the firing of the clinker kiln 2 as shown schematically with 14. The fuel supply for the firing of the calcinator 4 is shown schematically with 15.

The clinker cooler 6 has a plurality of fans 16 via which ambient air is blown in. The air passes through the clinker cooler 6 and leaves the clinker cooler 6 via the tertiary air extractor 17 and the tertiary air duct 18, wherein the tertiary air duct opens out into the calcinator 4.

Shown in FIG. 2 is an outline of a heat exchanger tower for preheating cement raw meal according to the invention. It can be seen that the heat exchanger tower has a supporting structure 19, which comprises three vertical stands 20, which in outline form a triangle 21. Arranged within the triangular outline of the supporting structure 19 and supported on the supporting structure 19 in a manner not shown in more detail, is a heat exchanger line consisting of a calcinator 4 and a plurality of heat exchangers 8, 9, 10, more particularly cyclone separators.

FIG. 2 shows that on the hot meal charging side the clinker kiln 2 is connected to the calcinator 4. The heat exchangers 8, 9 and 10 are arranged as shown in FIG. 1, wherein the path of the kiln exhaust gas from one heat exchanger to the next is schematically shown by arrows. The heat exchangers 8, 9 and 10 are essentially arranged in a central symmetrical manner about a central axis.

For comparison the outline of a conventional rectangular supporting structure of a heat exchanger tower as dimensioned in accordance with the prior art for accommodating the heat exchanger line shown in FIG. 2 is shown with a broken line 22. It can be seen that with the embodiment according to the invention the outline, and thereby the structural volume, can be considerably reduced.

In the embodiment according to FIG. 2 the calcinator 4 and the heat exchangers 8, 9, 10 of the heat exchanger line are arranged with their entire volume within the triangular outline 21. Only working areas, staircases or other structural entities used for inspection and maintenance etc. can be arranged outside the outline 21. The outline can be reduced even further if it is acceptable that with part of their volume the calcinator 4 and the heat exchangers 8, 9 and 10 project beyond the triangular outline, as shown in FIG. 3.

1. A device for pre-heating cement raw meal for cement clinker production comprising at least one heat exchanger line for charging cement raw meal in countercurrent flow to hot gases drawn through the heat exchanger line; and a supporting structure for the at least one heat exchanger line, wherein the heat exchanger line comprises a plurality of interconnected heat exchangers through which flow can pass consecutively, and the supporting structure (19) comprises stands (20) which serve to transfer load into at least one foundation and jointly form a triangular outline (21).

2. The device according to claim 1, wherein the supporting structure comprises three stands (20) arranged in a triangle (21).

3. The device according to claim 1, wherein the stands (20) essentially extend beyond the height of the heat exchanger line.

4. The device according to claim 1, wherein the stands (20) are arranged to transfer the main load of the heat exchanger line into the at least one foundation.

5. The device according to claim 1, wherein the stands (20) are hollow in design.

6. The device according to claim 1, wherein the stands (20) are arranged inclined towards each other.

7. The device according to claim 6, wherein the stands (20) are each inclined at an angle of 1-10° to the vertical.

8. The device according to claim 1, wherein the device further comprises struts or platforms for interconnecting the stands (20) to each other.

9. The device according to claim 1, wherein the heat exchangers comprise gas-suspension heat exchangers.

10. The device according to claim 1, wherein the heat exchangers project beyond the triangular outline (21) with part of their volume.

11. The device according to claim 1, wherein only one heat exchanger line is supported by the supporting structure (19) with its stands forming the triangular outline (21).

12. A combination comprising
a first device for pre-heating cement raw meal for the cement clinker production comprising at least one heat exchanger line for charging cement raw meal in countercurrent flow to hot gases drawn through the heat exchanger line and a supporting structure for the at least one heat exchanger line, wherein the heat exchanger line comprises a plurality of interconnected heat exchangers through which flow can pass consecutively, and the supporting structure (19) comprises stands (20) which serve to transfer load into at least one foundation and jointly form a triangular outline (21) with, directly adjoining it,
at least one further device, for pre-heating cement raw meal for the cement clinker production comprising at least one heat exchanger line for charging cement raw meal in countercurrent flow to hot gases drawn through the heat exchanger line and a supporting structure for the at least one heat exchanger line, wherein the heat exchanger line comprises a plurality of interconnected heat exchangers through which flow can pass consecutively, and the supporting structure (19) comprises stands (20) which serve to transfer load into at least one foundation and jointly form a triangular outline (21), wherein two stands (20) of the supporting structure (19) of the first device are at the same time stands (20) of the supporting structure (19) of the further device, wherein the first device and the at least one further device only have one heat exchanger line, respectively.

13. The combination according to claim 12, wherein the combination comprises two devices, wherein the two triangular outlines (21) of the two devices jointly from a rhombic outline.

14. The device according to claim 2, wherein the stands (20) essentially extend beyond the height of the heat exchanger line.

15. The device according to claim 14, wherein the strands (20) are hollow, are inclined towards each other, and are at an angle of 1-10° to the vertical.

16. The device according to claim 15, wherein a portion of the heat exchangers extend beyond the side edges of the triangular outline (21), and the heat exchangers comprise gas suspension heat exchangers.

17. The device according to claim 8, wherein the struts or platforms are arranged within the triangular outline (21).

18. The device according to claim 9, wherein the gas suspension heat exchangers comprise cyclone separators.
